(19) United States
(12) Patent Application Publication
(10) Pub. No.: US 2025/0312945 A1
(43) Pub. Date: Oct. 9, 2025

(54) METHOD AND APPARATUS FOR REMOVING IMPURITIES FROM AN IMPURE EXTRUDABLE MATERIAL

(71) Applicant: saperatec GmbH, Dessau-Roßlau (DE)

(72) Inventors: Jürgen Deinert, Dessau-Roßlau (DE); Marcus Schulze, Dessau-Roßlau (DE)

(21) Appl. No.: 18/864,623

(22) PCT Filed: May 12, 2023
(86) PCT No.: PCT/EP2023/062840

§ 371 Date: Nov. 11, 2024

(30) Foreign Application Priority Data
May 13, 2022 (LU) LU502091

(51) Int. Cl. B29B 7/84; B29C 48/275; B29C 48/40; B29C 48/57; B29C 48/67; B29C 48/69; B29C 48/76

(52) U.S. Cl. CPC B29B 7/845; B29C 48/277; B29C 48/40; B29C 48/57; B29C 48/67; B29C 48/69; B29C 48/767

(57) ABSTRACT

A method for extruding a recycled polymer from an impure extrudable material comprises injecting a non-solvent in a liquid state into an apparatus and mixing substantially homogeneously the non-solvent with the impure extrudable material, thereby forming a dispersion of the non-solvent with the impure extrudable material. The impurities are output in a gaseous state from the apparatus.

### CROSS-REFERENCE TO RELATED APPLICATIONS

The present application is a US National. Stage of International Application No. PCT/EP2023/062840 filed on May 12, 2023, which claims priority to Luxembourg Patent Application No. LU502091, filed on May 13, 2022.

### BACKGROUND OF THE INVENTION

### Field of the Invention

The invention comprises a method, an apparatus, and a recycled polymer for extruding the recycled polymer from an impure extrudable material.

### Brief Description of the Related Art

A number of patent applications are known which teach methods for recycling of polymers and include the decontamination or cleaning of the recycled polymers. For example, International Patent Application No. WO2021/123475 teaches a method for the decontamination of recycled plastics, such as polyethylene (PE), polypropylene (PP) or polyester (PET), from plastic waste. The method disclosed comprises a step of mixing a recycled plastic polymer containing organic contaminants with a water-soluble solvent in an extractor. A step of centrifugation is then applied to the mixture of the recycled plastic polymer and the water-soluble solvent, enabling transfer of the organic contaminants contained in the recycled plastic polymer into the water-soluble solvent in a liquid phase.

International Patent Application No. WO 2020/0245476 A1 teaches a method for eliminating volatile organic compounds responsible for odours in recycled plastics. The method comprises a step of injecting water in a gaseous phase (steam) into a distillation column comprising the recycled plastics. The volatile organic compounds are extracted from the recycled plastics by distillation and then the volatile organic compounds are output with the water/steam through an upper part of the distillation column.

A method for extruding polyphenylene ether/polystyrene resins of low odor from a solution comprising a polyphenylene ether resin and a polystyrene resin is described in European Patent Application No. EP 0 377 115 A2. The method for extruding polyphenylene ether/polystyrene resins comprises a first step of mixing, in a first apparatus, a solution comprising the polyphenylene ether resin and a liquid aromatic hydrocarbon solvent. A second step comprises heating the liquid polymeric solution and outputting a first fraction of volatiles in a gaseous form. This second step results in a partially devolatilized polymeric solution. The partially devolatilized polymeric solution is then transferred into a second apparatus. Steam or water is injected into the partially devolatilized polymeric solution and a second fraction of impurities is output from the partially devolatilized polymeric solution.

International Patent Application No. WO 2006/097470 teaches a method of removing residual styrene monomers from blends comprising polystyrene and polyvinylpyrrolidone. The method comprises mixing the blends comprising polystyrene and polyvinylpyrrolidone with water in a vessel. Steam is injected into the vessel comprising the polystyrene, the polyvinylpyrrolidone and the water and, at the same time, water is removed by condensation. In one aspect of the method, a stream of an inert gas, such as nitrogen or argon is injected instead of injecting water into the vessel comprising the polystyrene, the polyvinylpyrrolidone and the water.

Japanese Patent Application No. JP 2002/097362 describes a method to produce a resin for a molding having improved odor properties. The resin is a virgin polymer used in an electronic component. The method comprises the steps of introducing a polyphenylene ether-based resin and a polystyrene-based resin into an extruder and melt-kneading the polyphenylene ether-based resin and the polystyrene-based resin. Water in a liquid state is injected into the extruder. The polyphenylene ether-based resin and the polystyrene-based resin are subjected to a step of degassing by decompression. The degassing enables removal of odors from the polyphenylene ether-based resin and the polystyrene-based resin. The odors are residual monomers comprised in the polyphenylene ether-based resin, oligomers comprised in the polystyrene-based resin, and volatile components. The volatile components are, for example, volatile components or other byproducts generated by a decomposition of the polystyrene-based resin during the decompression. The volatile components are, in a further example, styrene monomers, 2,4,6-trimethylanisole, 7-methyldihydrobenzofuran, 2,3-dihydrobenzofuran, toluene, or ethylbenzene.

German Patent Application No. DE 808788 relates to a method for improving the properties of polystyrene or copolymers of styrene comprising volatile organic compounds. The method comprises a step of suspending the polystyrene or the copolymer of styrene in the form of beads or granules in water in a closed vessel. Water vapor is injected into the vessel. The water vapor in the vessel is then discharged from the vessel, enabling the transport of volatile organic compounds within the water vapor.

German patent application DE 3840293A1 discloses a method of removing impurities of monomers and/or oligomers from a component produced by polymerization. The component is a virgin polymer, and the method comprises using an extraction agent which is supercritical carbon dioxide. The method disclosed in this patent application is, however, not economical as it is expensive and difficult to maintain the supercritical carbon dioxide in the supercritical state.

Japanese patent JP 4 790517 B2 discloses a method and an apparatus of producing a thermoplastic resin composition. The thermoplastic resin composition is any of a polymer alloy, a polymer blend, a mixture of a thermoplastic resin and a filler. The method comprises supplying the thermoplastic resin composition from a supply port of the apparatus into a plasticization part and the thermoplastic resin composition is melted in the plasticization part. Liquid carbon dioxide is injected in a kneading part of the apparatus and the thermoplastic resin composition is kneaded at a high pressure of 10 MPa or more and less than 20 Mpa. The method further comprises performing a vacuum suction at a vacuum vent part of the apparatus via a vent port to perform a pressure reduction. The pressure reduction is at a pressure gradient of 3 MPa/sec or more and less than 10 GPa/sec to remove the carbon dioxide from the die of the apparatus.

US patent application U.S. Pat. No. 5,204,410 A discloses a method for removing volatile substances from polypropylene ether or polypropylene ether/styrene resin compositions. The resin compositions taught in this patent application are virgin polymers and are used for food contact. The volatile substances are typically typical styrene, catalyst fragments, e.g., trimethylanisole, trialkylamines, toluene, methyldihydrobenzofuran, dihydrobenzofuran, dimethylcyclo-hexanone, ethylhexenal, various amines. The method used in this patent application is not for the recycling of plastics. Carbon dioxide is suggested instead of water as an extraction agent. However, the combination of carbon dioxide and water is not taught in this document.

US patent application U.S. Pat. No. 5,851,065 A discloses a method and an apparatus for recycling a resin scrap. The resin scrap includes a thermosetting resin paint film and a thermoplastic resin substrate and is supplied into a passage of a cylinder. The resin scrap is subsequently melted to form a melt and the melt is delivered by screw arrays from an upstream side to a downstream side of the passage of the cylinder. The thermosetting resin in the melt is hydrolyzed by a hydrolyzing agent (such as water). The melt forms a highly packed region with a resistor to restrict the flow of the melt and thereby enhance the contact efficiency with the resin scrap and the water. The hydrolyzation results in a destruction of the three-dimensionally cross-linked construction of the resin scrap into decomposed components. The water resulting from the hydrolyzation of the resin scrap is degassed by vaporizing the water content and the decomposed components are partially discharged together with the water by the vaporizing of the water. The method set out in this document is not as effective as removal of impurities using water from a melt of virgin polymer as the decomposed components diffuse insufficiently through the melt of recycled plastics.

European patent application EP 0 375 937 A2 discloses a method for a reduction of impurities in a composition. The composition is a virgin polymer that is substantially odorless and tasteless for food contact application. The composition comprises a polyphenylene ether resin, alone, or in combination with a styrene resin and has further the impurities selected from styrene monomer, toluene, volatile odoriferous oxygenated species, sources of volatile odoriferous amines, mixtures of any of them and the like. The method comprises extruding the composition at a temperature above the melting point of the composition. The extruding is conducted in one pass in at least two stages. The two stages comprise water injecting followed by vacuum venting.

International patent application WO 2012/108245 A1 discloses a method for manufacturing a virgin polymer which are in the form of a polycarbonate resin. The polycarbonate resin pellets have a reduced methylene chloride content. The method comprises the steps of starting from a polycarbonate resin having a specific powder or granular form and moving the polycarbonate resin in an inert gas atmosphere having an oxygen concentration of 3 vol % or less. The polycarbonate resin falls in the inert gas atmosphere by 50 cm or more. A specified amount of water having an electrical conductivity of 30 μS/cm or less is injected into a kneading zone of an extruder. A further step of the method is a step for removing the methylene chloride together with the water from the polycarbonate resin and adjusting the moisture concentration in the polycarbonate resin to 10-200 ppm by evacuating through a vent hole provided downstream of the kneading zone. A strand-shaped molten resin is extruded through a die into a water bath. The introduction of the strand-shaped molten resin enables cooling of the strand-shaped molten resin. The strand-shaped molten resin is cut at 70-130° C. to produce pellets. The method further comprises allowing the pellets with a water content of 10-200 ppm to further absorb water in a wet atmosphere, thereby adjusting the water content of the pellets to a value greater than the initial water content of the pellets and equal to or lower than 1300 ppm.

Korean patent application KR 2012 0029407 A discloses an apparatus and a method for devolatilizing a solvent-containing polycarbonate solution to produce a virgin polymer of polycarbonate. The apparatus comprises a devolatilizer and an extruder. The method comprises injecting and mixing an inert component, such as nitrogen, argon, carbon dioxide, water, methane, or helium into a polymer melt stream upstream of a downflow devolatilizer. The inert component is injected as an azeotropic additive in the extruder.

These prior art methods described producing virgin polymers, i.e., new manufactured polymers, with a residual concentration of the impurities in the virgin polymers of max. 250 ppm. The impurities in the virgin polymers have been intentionally introduced during the manufacturing process of the virgin polymers. The impurities are, for example, used solvents and used monomers introduced during the manufacturing. These intentionally introduced solvents and monomers have to then be removed from the polymer melt of the virgin polymers.

The recycled polymers described in the prior art comprises short-chain segments. One of the challenges with melts made of recycled polymers is that “gels” are formed within the melts. Any water placed into the melt will not disperse in the polymer gels and, therefore, the water is unable to remove impurities incorporated into in the polymer gels. The melts will therefore maintain these impurities when they are re-extruded.

International patent application WO 2021/048756 A1 discloses a process for a recovery and for a devulcanization of a vulcanized rubber. Water is used for cutting sulfur bonds in the rubber. The use of carbon dioxide and water together is not taught in this document.

### SUMMARY OF THE INVENTION

A method for extruding a recycled polymer from an impure extrudable material is taught in this disclosure. The method comprises injecting a non-solvent in a liquid state into an apparatus and mixing substantially homogeneously the non-solvent with the impure extrudable material, thereby forming a dispersion of the non-solvent with the impure extrudable material. The non-solvent is injected into the extruder in a liquid state, which enables a homogeneous dispersion in the liquid state of the non-solvent with the impure extrudable material. The formation of the dispersion of the non-solvent with the impure extrudable material enables simultaneously the extraction of impurities from the impure extrudable material and the obtention of a gaseous phase comprising the impurities and the non-solvent. There is thus no need to apply two separate steps in the method to separate firstly the impurities from the impure extrudable material and secondly to evaporate the impurities and the non-solvent.

The recycled polymer is a polymer made from post-consumer waste or industrial waste and has a concentration of impurities of below 10 ppm in one aspect of the invention.

The method set out in this document enables cleaning of the impure extrudable material by removing a substantial portion of the impurities from the impure extrudable material. The method produces a recycled polymer with a residual concentration of the impurities in the recycled polymer of below 100 ppm and, in another aspect, below 10 ppm.

The impurities in the recycled polymers are substances that have been unintentionally introduced into polymer waste, such as foodstuffs. It has been found that there are more than 30 different types of impurities, such as polar and non-polar, protic and aprotic impurities in the recycled polymer. These impurities have to be removed from the recycled polymers because of the effect of the residual impurities on the odor, taste, feel and strength of the recycled polymer.

The method set out in this document is in line with the European Commission's (EC) Regulation (EU) 2022/1616 of Sep. 15, 2022, on recycled plastic materials and articles intended to come into contact with foods.

The method enables the use of elevated temperatures and pressures which means that transport mechanism to remove the non-solvents with the impurities is accelerated. The reduction in the number of steps means that the method takes less time to carry out and so less solvent is needed to achieve the extraction of the impurities from the impure extrudable material. The substantially homogeneous mixing of the non-solvent with the impure extrudable material enables quick process times, thus a small amount of the non-solvent is needed to remove the impurities from the impure extrudable material. The method for extruding the recycled polymer requires only a small amount of non-solvent, and therefore has economic advantages and also ecological advantages.

The non-solvent with the impurities is expelled in a gaseous state from the extruder.

The non-solvent forms a mixture with the impurities and forms, in one aspect, an azeotrope mixture with the impurities.

The non-solvent is chosen from at least one of water, a mixture of water, a base, an ester, an alcohol, an ether, an alkane, or a ketone. The alcohol is selected, for example, from methanol, ethanol, or isopropanol. The base is at least one of ammonia or pyridine.

The non-solvent is, in one aspect, a mixture of water and carbon dioxide, the carbon dioxide at a concentration between 10% and 50% by weight in water. It was a surprising result that the water was able to remove the impurities as the prior art had indicated that the use of water in recycled plastics did not enable a sufficiently fine dispersion of the water in the recycled plastics to enable this removal. The carbon dioxide acts as a catalyst. The use of the carbon dioxide over alternative acidic catalysts or basic catalysts is ecologically more favourable as carbon dioxide is easily removed from the melts. Furthermore, the carbon dioxide leaves no residues in the extruded plastics which might cause issues when products made from the extruded plastics are brought into contact with living agents.

In one aspect, the impurities are impurities which have a molecular weight of at most 500 g/mol and in one aspect at most 160 g/mol. Examples of the impurities are, for example, from one or more of carboxylic acids, aldehydes, terpenes, aromatics, olefins, alkanes, nitrogen-based compounds, phosphor-based compounds, sulfur-based compounds, or a mixture thereof.

In one non-limiting aspect, the impure extrudable material is passed through a melt filter prior to the injecting of the non-solvent. It is also possible to pass the impure extrudable material through a melt filter after the injecting of the non-solvent. In a further aspect, two melt filters can be used which are located before and after the injecting of the non-solvent.

The mixing of the non-solvent with the impure extrudable material is conducted, for example, at a temperature between 110° C. and 330° C. and at a pressure between 2 and 300 bars.

The method further comprises a step of outputting the recycled polymer in water to cool the recycled polymer and then subsequently or concurrently cutting the polymer to form granules of the polymer.

An apparatus for removing impurities from an impure extrudable material is also disclosed. The apparatus comprises an injector for injecting a non-solvent in a liquid state into the impure extrudable material, a mixing element for mixing substantially homogeneously the non-solvent with the impure extrudable material and an output device for outputting the impurities in a gaseous state from the apparatus.

The mixing element comprises a screw device in a housing. The mixing element further comprises one of a single screw or multiple screws, for example a double screw.

The screw device further comprises one of a kneading block or a toothed disk.

The apparatus further comprises a heating device for heating the impure extrudable material.

A recycled polymer is also disclosed. The recycled polymer comprises a polyolefin and impurities, wherein individual ones of the impurities are substantially homogeneously distributed in the recycled polymer and wherein the concentration of the individual ones of the impurities in the recycled polymer are respectively at most 10 ppm by weight and, in a further aspect, at most 5 ppm by weight.

The polyolefin comprises polyethylene or polypropylene.

The recycled polymer has low odor properties.

A use of a recycled polymer is also disclosed, for example in a consumer package.

### BRIEF DESCRIPTION OF THE FIGURES

FIG. 1 shows a view of an apparatus for removing impurities from an impure extrudable material.

FIG. 2 shows an aspect of the apparatus with a screw device within a housing.

FIG. 3 shows an enlarged view of a mixing element comprising a kneading block.

FIG. 4 shows an enlarged view of the mixing element comprising a toothed disk.

FIG. 5 shows a flow chart describing a method for extruding a recycled polymer from an impure extrudable material.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with the feature of a different aspect or aspects and/or embodiments of the invention.

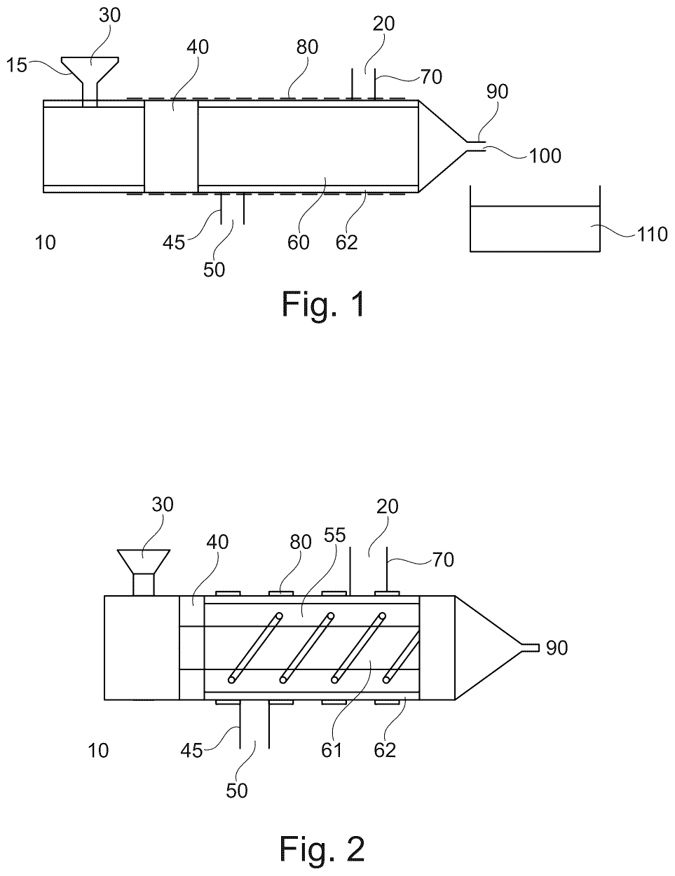

FIG. 1 shows an example of an apparatus 10 for removing impurities 20 from an impure extrudable material 30. The apparatus 10 can be, for example, an extruder. The apparatus 10 comprises a hopper 15, a housing 62 and a material outlet 90. The impure extrudable material 30 is within the housing 62 and an injector 45 attached to the housing 62 enables injecting of a non-solvent 50 in a liquid state into the impure extrudable material 30. Heating elements 80 are present in the apparatus 10 to heat the impure extrudable material 30.

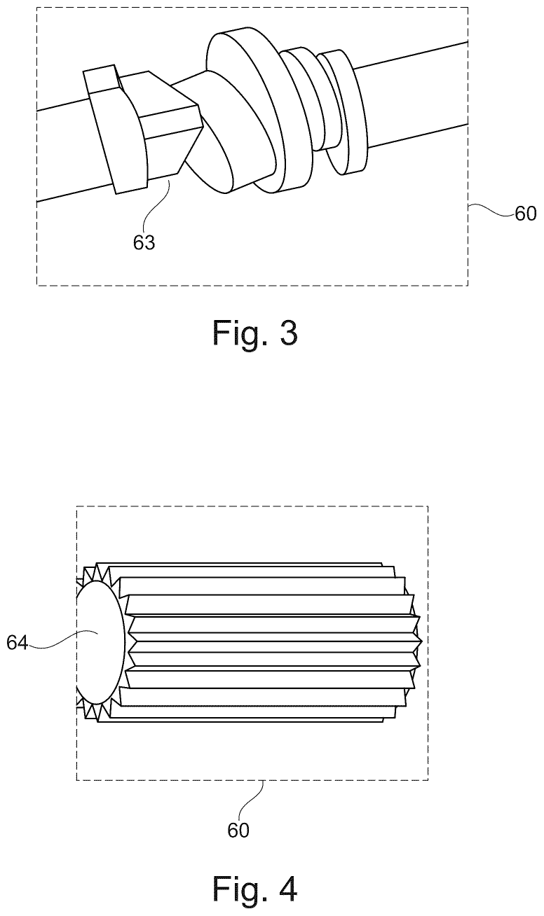

The housing 62 encloses a mixing element 60. The mixing element 60 enables the mixing in a substantially homogeneously manner of the non-solvent 50 with the impure extrudable material 30. The mixing element 60 can be a screw device 61, as shown in FIG. 2, which could be a single screw or a double screw. The mixing element 60 may also be kneading block 63, as shown in FIG. 3, or toothed disks 64, as shown in FIG. 4.

The apparatus 10 further comprises an output device 70 for outputting the impurities 20 in a gaseous state from the apparatus 10. A recycled polymer 100 is outputted from the material outlet 90 into a water bath 110 filled with water. The output of the recycled polymer 100 into the water bath 110 cools the output recycled polymer 100. The recycled polymer 100 is cut in the form of granulates or pellets at the same time as it is output into the water bath 110 or after cooling in the water bath 110.

The apparatus 10 may also comprise a melt filter 40. In one aspect, the melt filter 40 is placed prior to the injector 45 and serves to remove impurities comprised in the impure extrudable material 30. The impurities can be solid contaminants, such as particulates, unconverted polymers, carbonized polymers, agglomerated additives, and debris such as metal particles, dirt, or dust.

In another aspect, the melt filter 40 is placed after (i.e., downstream of) the injector 45.

In this disclosure, the term “impure extrudable material” means a polymer material which is capable of being heated and extruded. The extrudable material 30 provided to the material input 15 contains a high concentration of impurities 20.

In one non-limiting example, the impure extrudable material comprises a concentration of impurities 20 of at least 70 ppm. In another example, the impure extrudable material 30 comprises a concentration of impurities 20 of 60 ppm and more.

In one aspect, the impure extrudable material 30 comprises polyolefins. The polyolefins are polyethylene (PE), polypropylene (PP), or a mixture thereof. The impure extrudable material 30 may be low-density polyethylene (LDPE), linear low-density polyethylene (LLDPE), medium-density polyethylene (MDPE), high-density polyethylene (HDPE), polymethylpentene (PMP), polyisobutylene (PIB), polybutylene (PB), or a mixture thereof. The impure extrudable material 30 may be polyethylene terephthalate (PET), a polyamide (PA) like a copolyamide 6/66 (PA 6/66), polylactic acid (PLA) or a cellulose acetate (CA).

The impure extrudable material 30 is, for example, derived from packaging material. The impure extrudable material 30 comes for example from post-consumer packaging material like food packaging, pharmaceuticals, cosmetics, and oral care materials. In another example, the impure extrudable material 30 is a recycled material, for example a recycled material coming from a refuse collection system, a so-called “yellow bag” (German package collection system “gelber Sack”), a sorting center, or a paper mill. The recycled material can be subjected to a step of sorting and separation, e.g., by wind sifting, by defibering techniques, and/or a step of washing, e.g., with water or a lye prior to the extrusion of the recycled polymer from the impure extrudable material.

The term “low molecular impurities” used in this disclosure means molecules having a molecular weight of at most 500 g/mol. In one example, the low molecular impurities 20 have a molecular weight between 40 and 160 g/mol and, in a further example, the low molecular impurities 20 have a molecular weight between 60 and 130 g/mol.

In one aspect, the impurities 20 are one or more of carboxylic acids, aldehydes, terpenes, aromatics, olefins, alkanes, nitrogen-based compounds, phosphor-based compounds, sulfur-based compounds, or a mixture thereof. In one example, the impurities 20 comprise limonene, N-ethylformamide, N, N-dimethyl-guanidine, N-methoxymethyl-N-methylformamide, hexadecane, tetradecanoic acid, octadecane, n-hexadecanoic acid, eicosane, cis-13-octadecenoic acid, octadecanoic acid, docosane, tricosane, tetracosane, pentacosane, bis(2-ethylhexyl) phthalate, hexacosane, heptacosane, 1,3-benzenedicarboxylic acid, bis(2-ethylhexyl) ester, nonadecane and a mixture thereof.

The term “non solvent” encompasses a compound that is unable to dissolve the impure extrudable material 30. Examples of the non-solvent 50 include water, a mixture of water, a base, an ester, an ether, an alkane, an alcohol, or a ketone. The base is for example ammonia or pyridine. The ester is for example ethyl acetic ester. The alcohol comprises methanol, ethanol, or isopropanol. The ketone is for example propanone.

The recycled polymer 100 has mechanical and sensory properties. The recycled polymer 100 has low odor properties.

Removing the impurities 20 from the impure extrudable material 30 leads to a recycled polymer 100 having good mechanical properties, such as toughness, elongation at break and strength. This is due to the removal of structural defects in the recycled polymer.

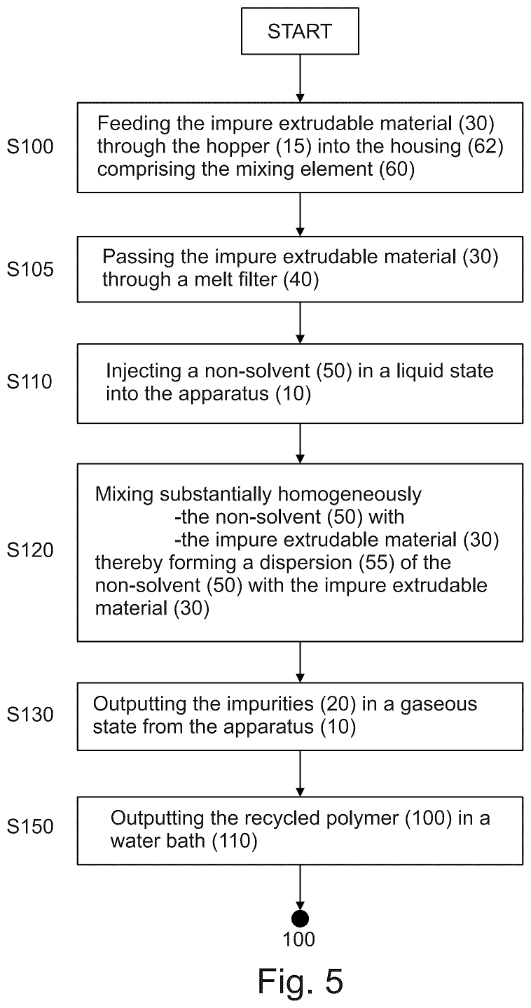

FIG. 5 illustrates a method for extruding the recycled polymer 100 from an impure extrudable material 30. In step 100, the impure extrudable material 30 is fed through the hopper 15 into the housing 62 comprising the mixing element 60 and is melted using the heating device 80. The rotation of the mixing element 60 forwards the impure extrudable material 30 in a melted state through the apparatus 10. The temperature inside the housing 62 increases due to the work done on the impure extrudable material 30 by rotation of the mixing element 60 and the heating of the housing 62 by the heating device 80. For example, the temperature inside the housing is between 110° C. and 330° C. and in a further aspect between 200° C. and 230° C. For example, the temperature inside the housing is between 130° C. and 230° C., between 180° C. and 230° C., between 250° C. and 290° C. or between 250° C. and 310° C. The increase of the temperature causes an increase of the pressure inside the housing 62. The pressure inside the housing 62 can be, for example, between 2 and 300 bars. The pressure inside the housing 62 is dependent on the nature of the impure extrudable material 30, the nature of the non-solvent 50, the temperature inside the housing 62 and the rotation per minute of the mixing element 60. The pressure is chosen so that non-solvent 50 does not evaporate in the housing 62 but remains in a liquid state. The elevated temperatures and the high pressure in the apparatus enable to speed up the method for extruding the recycled polymer 100 from the impure extrudable material 30. The term “high pressure” means the pressure must be applied to prevent evaporation of the non-solvent 50 in the injection zone at the respective process temperature.

In step S110, the non-solvent 50 in a liquid state is injected into the apparatus 10. The non-solvent 50 is injected into the apparatus 10 at a pressure so that the pressure inside the housing 62 of the apparatus 10 is above the vapor pressure of the non-solvent. At this pressure in the apparatus 10, the non-solvent 50 is inside the housing 62 in the liquid state, preventing the formation of foam inside the apparatus 10 and enabling the homogeneous mixing of the non-solvent 50 and the impure extrudable material 30. In step 120, the non-solvent 50 and the impure extrudable material 30 are mixed substantially homogeneously together by the mixing element 60 to form a dispersion 55 of the non-solvent 50 with the impure extrudable material 30. In one aspect of the invention, the non-solvent 50 and the impurities 20 form an azeotrope mixture. The homogeneous mixing of the non-solvent 50 and the impure extrudable material 30 enables a better absorption of the impurities 20 in the non-solvent 50 because the length of diffusion in the homogenous mixture is small and thus facilitates a removing of the impurities 20 from the impure extrudable material 30.

At the output device 70, the pressure inside the housing 62 decreases, enabling the impurities 20 in the non-solvent 50 to pass from the liquid state into the gaseous state. In step 130 the impurities 20 are output in a gaseous state from the apparatus 10 at the output device 70. In one aspect, the impurities 20 in the gaseous state are output in a vacuum from the apparatus 10. This (partial) vacuum is created for example by using a water ring vacuum pump. Outputting the impurities 20 in the gaseous state in a vacuum enables a better extraction of the impurities 20 from the impure extrudable material 30 into the non-solvent 50. The recycled polymer 100 is forced through the material outlet 90 in step 150 to be output into the water bath 110 to be cooled. The recycled polymer 100 is cut into granules at the material outlet 90.

The term “azeotrope mixture” means a mixture in which the mole fractions of all components in the liquid state are equal to the mole fractions of all components in the vapor state. The impure extrudable material 30 comprising the impurities 20 is heated in the apparatus 10. The injection of the non-solvent 50 enables the formation of an azeotrope mixture between the impurities 20 and the non-solvent 50. The non-solvent 50 is injected into the apparatus 10 at a pressure, for example at a pressure of 3-90 bars, and in one aspect between 50 and 80 bars. The temperature of the mixture in the apparatus 10 means the impurities 20 will be drawn into the non-solvent 50. The impurities 20 will be subsequently removed from the impure extrudable polymer 30 through the output device 70 in step 130.

In one example, the mixing element 60 has a low flight depth or a low screw pitch.

In one embodiment, the impure extrudable material 30 is passed through the melt filter 40 in step 105 before the injecting of the non-solvent 50 into the apparatus 10.

### Examples of Process Conditions for Extruding a Recycled Polymer

The compositions listed below are merely examples of suitable formulations and are not limiting of the invention (all percentages by weight):

The concentration of the following components of the impure extrudable material is measured by differential scanning calorimetry (DSC). The concentration of the impurities is measured by gas chromatography-mass spectrometry (GC-MS). The pressure in the injector is measured by a manometer.

Composition 1

| | |
|---|---|
| LDPE | 75% |
| LLDPE | 9% |
| HDPE | 10% |
| PP | 6% |

Composition 2

| | |
|---|---|
| PP | 79% |
| HDPE | 12% |
| LDPE | 6% |
| LLDPE | 3% |

Composition 3

| | |
|---|---|
| LDPE | 100% |

Composition 4

| | |
|---|---|
| PA6/66 | 100% |

Composition 5

| | |
|---|---|
| PET | 100% |

Composition 6

| | |
|---|---|
| CA | 100% |

The examples listed below are merely examples of suitable process conditions for extruding a recycled polymer from an impure extrudable material and are not intended to be limiting of the invention. Examples 1 to 5 elucidate different impure extrudable material which can be processed to obtain a recycled polymer.

### Example 1

The impure extrudable material has a shape of colored flakes from post-consumer packaging material. The colored flakes have, for example, an irregular geometry, a thickness below 50 μm. The concentration of the impurities in the impure extrudable material is 1.5%. The composition of the non-solvent injected into the apparatus is 43% water and 57% pyridine. The pressure in the injector is 21 bar. The concentration of impurities in the recycled polymer at the end of the process is <0.1%.

### Example 2

The impure extrudable material has a shape of colored flakes from post-consumer packaging material. The concentration of the impurities in the impure extrudable material is 1.2%. The composition of the non-solvent injected into the apparatus is acetic ethyl ester. The pressure in the injector is 36 bar. The concentration of the impurities in the recycled polymer at the end of the process is <0.05%.

### Example 3

The impure extrudable material has a shape of colorless flakes from post-industrial recyclates. The concentration of the impurities in the impure extrudable material is 1.1%. The composition of the non-solvent injected into the apparatus is isopropanol.

The pressure in the injector is 28 bar. The concentration of the impurities in the recycled polymer at the end of the process is <0.01%.

### Example 4

The impure extrudable material has is derived from a film waste. The impure extrudable material has for example a uniform geometry, a thickness above 50 μm. The concentration of the impurities in the impure extrudable material is 1.5%. The composition of the non-solvent injected into the apparatus is dioxane. The pressure in the injector is 72 bar. The concentration of impurities in the recycled polymer at the end of the process is <0.1%.

### Example 5

The impure extrudable material is derived from a transfer film. The concentration of the impurities in the impure extrudable material is 1.2%. The composition of the non-solvent injected into the apparatus is cyclohexane. The pressure in the injector is 27 bar. The concentration of the impurities in the recycled polymer at the end of the process is <0.1%.

### Example 6

The impure extrudable material is derived from a fiber recyclate. The concentration of the impurities in the impure extrudable material is 1.2%. The composition of the non-solvent injected into the apparatus is water. The pressure in the injector is 76 bar. The concentration of the impurities in the recycled polymer at the end of the process is <0.05%.

### REFERENCE NUMERALS

10 apparatus
15 hopper
20 impurities
30 impure extrudable material
40 melt filter
45 injector
50 non-solvent
55 dispersion
57 polymer melt
60 mixing element
61 screw device
62 housing
63 kneading block
64 toothed disks
65 single screw
66 multiple screws
70 output device
80 heating device
90 material outlet
100 recycled polymer
110 water bath

1. A method for extruding a recycled polymer (100) from an impure extrudable material comprising the steps of:
injecting a non-solvent in a liquid state into an apparatus;
mixing substantially homogeneously the non-solvent with the impure extrudable material and thereby forming a dispersion of the non-solvent with the impure extrudable material;
outputting impurities in a gaseous state from the apparatus.

2. The method of claim 1, wherein the non-solvent forms an azeotrope mixture with the impurities.

3. The method of claim 1, wherein a residual concentration of impurities in the recycled polymer is below 10 ppm.

4. The method of claim 1, wherein the non-solvent is chosen from at least one of water, a mixture of water, a base, an ester, an alcohol, an ether, an alkane, or a ketone.

5. The method of claim 1, wherein the base is at least one of ammonia or pyridine.

6. The method of claim 1, wherein the non-solvent chosen from an alcohol is selected from methanol, ethanol, or isopropanol.

7. The method of claim 1, wherein the non-solvent is a mixture of water and carbon dioxide, preferably a mixture of carbon dioxide at a concentration between 10% and 50% by weight in water.

8. The method of claim 1, wherein the impurities have a molecular weight of at most 500 g/mol, preferably 160 g/mol.

9. The method of claim 1, wherein the impurities are chosen from one or more of carboxylic acids, aldehydes, terpenes, aromatics, olefins, alkanes, nitrogen-based compounds, phosphor-based compounds, sulfur-based compounds, or a mixture thereof.

10. The method of claim 1, wherein a step of passing the impure extrudable material through a melt filter is conducted prior to the injecting.

11. The method of claim 1, wherein the mixing of the non-solvent with the impure extrudable material is conducted at a temperature between 110° C. and 330° C.

12. The method of claim 1, wherein the mixing of the non-solvent with the impure extrudable material is conducted at a pressure between 2 and 300 bars.

13. An apparatus for removing impurities from an impure extrudable material comprising:
an injector for injecting a non-solvent in a liquid state into the impure extrudable material;
a mixing element for mixing substantially homogeneously the non-solvent with the impure extrudable material;
an output device for outputting the impurities in a gaseous state from the apparatus.

14. The apparatus of claim 13, wherein the non-solvent is chosen from at least one of water, a mixture of water, a base, an ester, an alcohol, an ether, an alkane, or a ketone.

15. The apparatus of claim 13, wherein the base is at least one of ammonia or pyridine.

16. The apparatus of claim 13, wherein the non-solvent chosen from an alcohol is selected from methanol, ethanol, or isopropanol.

17. The apparatus of claim 13, wherein the impurities have a molecular weight of at most 500 g/mol, preferably 160 g/mol.

18. The apparatus of claim 13, wherein the impurities are chosen from one or more of carboxylic acids, aldehydes, terpenes, aromatics, olefins, alkanes, nitrogen-based compounds, phosphor-based compounds, sulfur-based compounds, or a mixture thereof.

19. The apparatus of claim 13, wherein the mixing element comprises a screw device in a housing.

20. The apparatus of claim 13, wherein the mixing element comprises one of a single screw or multiple screws.

21. The apparatus of claim 13, wherein the screw device comprises one of a kneading block or a toothed disk.

22. A recycled polymer comprising a polyolefin and impurities, wherein individual ones of the impurities are substantially homogeneously distributed in the recycled polymer and wherein the concentration of the individual ones of the impurities in the recycled polymer are respectively at most 10 ppm by weight.

23. The recycled polymer of claim 22, wherein the concentration of the individual ones of the impurities in the recycled polymer is at most 5 ppm by weight.

24. The recycled polymer of claim 22, wherein the impurities have a molecular weight of at most 500 g/mol, preferably 160 g/mol.

25. The recycled polymer of claim 22, wherein the impurities are chosen from one or more of carboxylic acids, aldehydes, terpenes, aromatics, olefins, alkanes, nitrogen-based compounds, phosphor-based compounds, sulfur-based compounds, or a mixture thereof.

26. The recycled polymer of claim 22, wherein the polyolefin comprises polyethylene or polypropylene.

27. The recycled polymer of claim 22, having low odor properties.

28. A use of a recycled polymer of claim 22 in a consumer package.
